(19) United States
(12) Patent Application Publication
(10) Pub. No.: US 2006/0144859 A1
(43) Pub. Date: Jul. 6, 2006

(54) Gas-powered glue gun

(76) Inventor: Arlo Lin, Road Town (VG)

Correspondence Address: NIKOLAI & MERSEREAU, P.A., 900 SECOND AVENUE SOUTH, SUITE 820, MINNEAPOLIS, MN, 55402, US

(21) Appl. No.: 11/028,019

(22) Filed: Jan. 3, 2005

(51) Int. Cl. B67D 5/62

(52) U.S. Cl. 222/146.6

(57) ABSTRACT

A gas-powered glue gun includes a shell, a burner, a body, a heat sink and a nozzle. The burner is installed in the shell in order to generate heat through burning gas. The body receives a glue stick. Furthermore, the body receives the heat from the burner. The heat sink receives the glue stick from the body. Moreover, the heat sink receives the heat from the body. The heat sink melts the glue stick with the heat. The nozzle dispenses the molten glue to the exterior from the heat sink.

### BACKGROUND OF INVENTION

1. Field of Invention

The present invention relates to a gas-powered glue gun with a high thermal efficiency.

2. Background of Invention

According to U.S. Pat. No. 5,799,648, a conventional glue gun 80 includes a shell 81 consisting of a main portion 82 and a handle portion 83. A main body 85 is installed in the main portion 82 of the shell 81. The main body 85 defines a combustion chamber 10 and an exhaust port 21 communicated with the combustion chamber 10. A combustion element 12 is put in the combustion chamber 10. A barrel 84 is put in the main portion 82 of the shell 81. The barrel 84 is connected with the main body 85 so that heat can be transferred to the barrel 84 from the main body 85. Solid glue is fed to and stored in the barrel 84. The solid glue is heated and molten in the barrel 84. The molten glue is dispensed from the barrel 84. Problems have been encountered in operation of the glue gun 80. Firstly, it takes quite some time for heat to reach the barrel 84 from the main body 85. This entails a high operative cost. Secondly, it is difficult for exhaust to leave the combustion chamber 10 through the exhaust port 21 for the exhaust is hot and tends to rise while the exhaust port 21 extends downwards. An undesired amount of heat accumulates in the combustion chamber 10. The temperature of the main body 85 and the barrel 84 reaches an undesired value. This high temperature may damage the glue gun and hurt a user.

The present invention is therefore intended to obviate or at least alleviate the problems encountered in prior art.

### SUMMARY OF INVENTION

According to the present invention, a gas-powered glue gun includes a shell, a burner, a body, a heat sink and a nozzle. The burner is installed in the shell in order to generate heat through burning gas. The body receives a glue stick. Furthermore, the body receives the heat from the burner. The heat sink receives the glue stick from the body. Moreover, the heat sink receives the heat from the body. The heat sink melts the glue stick with the heat. The nozzle dispenses the molten glue to the exterior from the heat sink.

The primary advantage of the according to the present invention is a high thermal efficiency because of the use of the heat sink.

Other objects, advantages and novel features of the invention will become more apparent from the following detailed description in conjunction with the attached drawings.

### BRIEF DESCRIPTION OF DRAWINGS

The present invention will be described via detailed illustration of the preferred embodiment referring to the drawings.

FIG. 1 is an exploded partial view of a gas-powered glue gun according to the preferred embodiment of the present invention.

FIG. 2 is a cross-sectional view of the glue gun shown in FIG. 1.

FIG. 3 is similar to FIG. 2 but shows how heated air flows in the glue gun.

FIG. 4 is an enlarged partial view of the glue gun shown in FIG. 3.

### DETAILED DESCRIPTION OF PREFERRED EMBODIMENT

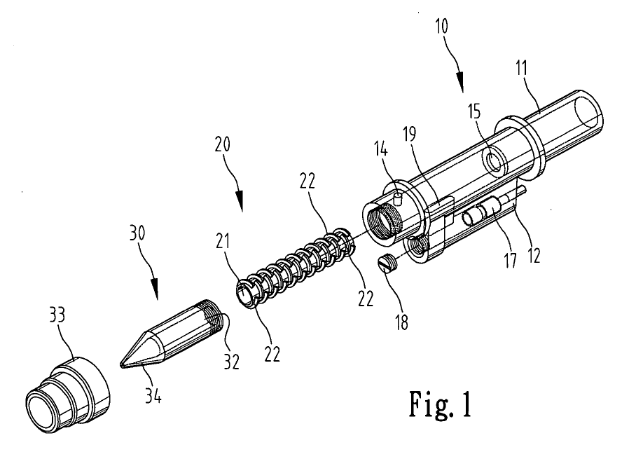

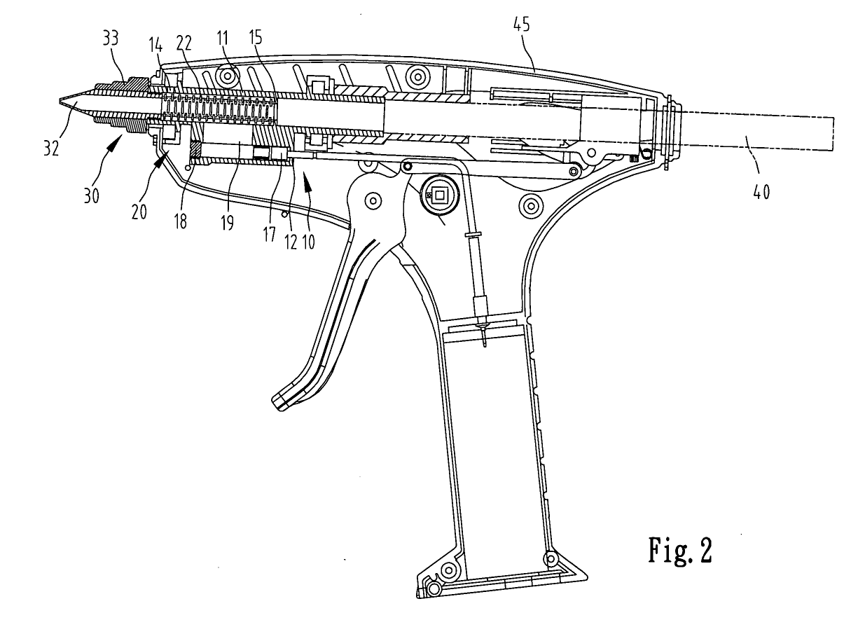

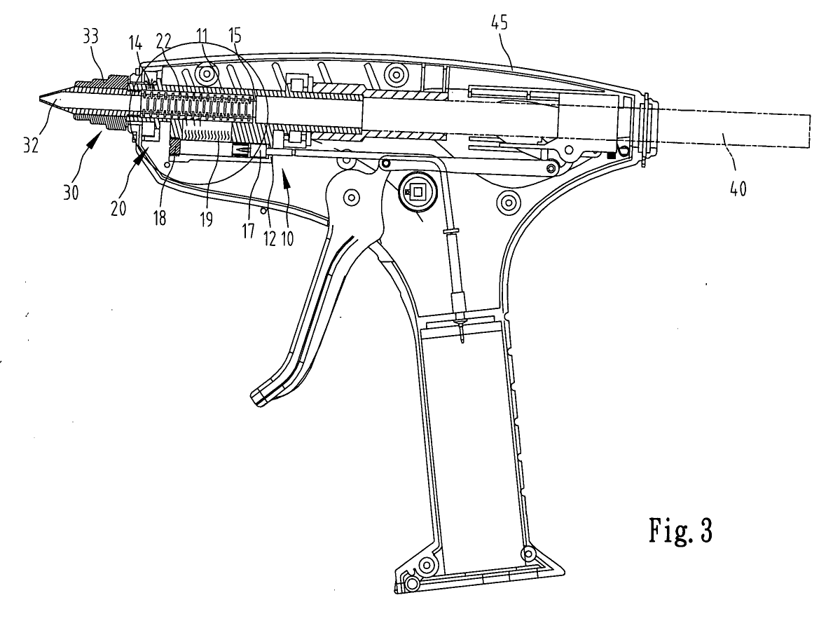

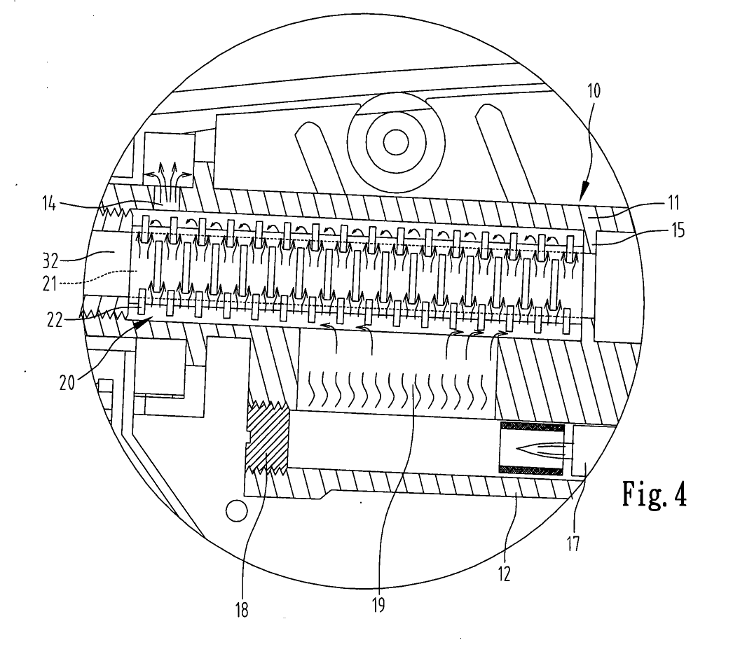

Referring to FIGS. 1 through 4, a gas-powered glue gun includes a shell 45, a burner 17, a body 10, a heat sink 20 and a nozzle 30. The burner 17 is installed in the shell 45 in order to generate heat through burning gas. The body 10 receives a glue stick 40. Furthermore, the body 10 receives the heat from the burner 17. The heat sink 20 receives the glue stick 40 from the body 10. Moreover, the heat sink 20 receives the heat from the body 10. The heat sink 20 melts the glue stick 40 with the heat. The nozzle 30 dispenses the molten glue to the exterior from the heat sink 20.

The body 10 includes a combustion chamber 12 and a barrel 11 formed next to the combustion chamber 12. The burner 17 is installed in the combustion chamber 12. To this end, the combustion chamber 12 includes an open end that can be closed by means of a cover 18. An exhaust port 14 extends upwards to the exterior from the barrel 11. Exhaust can be expelled to the exterior from the barrel 11 through the exhaust port 14 smoothly because hot air tends to rise and because the exhaust port 14 extends upwards to the exterior from the barrel 11. An annular shoulder 15 extends on the internal side of the barrel 11, thus dividing the barrel 11 into a first section for receiving the glue stick 40 and a second section communicated with the combustion chamber 12 through a passage 19.

The heat sink 20 is inserted in the second section of the barrel 11. The heat sink 20 includes a tube 21 and first, second, third and fourth groups of fins 22 formed on the external side of the tube 21. The heat sink 20 is inserted in the second section of the barrel 11. The groups of fins 22 are at 90 degrees from one another as viewed in the axial direction of the heat sink 20. The groups of fins 22 are arranged alternately as viewed in a transverse direction of the heat sink 20. Thus, the curved passages (not numbered) are defined by means of the fins 22. Heated air flows in the curved passages for quite some time in which the fins 22 fully absorb the heat from the heated air.

The nozzle 30 includes a first end 32 connected with the heat sink 20 and a tapered second end 34 extending to the exterior. A protective collar 33 is used to shield the nozzle 30 except for the second end 34.

In the glue gun according to the present invention, heat is transferred in two manners. Firstly, heat is transferred to the barrel 11 from the combustion chamber 12. In the barrel 11, the glue stick 40 is heated. Secondly, heat is transferred to the heat sink 20 from the heated air. In the heat sink 20, the glue stick 40 is further heated and finally molten. The present invention has been described via detailed illustration of the preferred embodiment. Those skilled in the art can derive variations from the preferred embodiment without departing from the scope of the present invention. Therefore, the preferred embodiment shall not limit the scope of the present invention defined in the claims.

What is claimed is:

1. A glue gun comprising a
a shell;
a burner installed in the shell in order to generate heat through burning gas;
a body for receiving a glue stick and for receiving the heat from the burner;
a heat sink for receiving the glue stick from the body and for receiving the heat from the body and for melting the glue stick with the heat; and
a nozzle for dispensing the molten glue to the exterior from the heat sink.

2. The glue gun according to claim 1 wherein the body comprising:
a combustion chamber for housing the burner; and
a barrel for receiving the glue stick and for receiving the heat from the combustion chamber.

3. The glue gun according to claim 2 wherein the body comprises an exhaust port extending upwards to the exterior from the barrel.

4. The glue gun according to claim 2 wherein the barrel is formed next to the combustion chamber.

5. The glue gun according to claim 4 wherein the body comprises a passage for communicating the barrel with the combustion chamber.

6. The glue gun according to claim 2 wherein the barrel comprises a first section for receiving the glue stick and a second section for receiving the heat sink.

7. The glue gun according to claim 6 wherein the barrel comprises an annular shoulder extending on the internal side between the first and second sections.

8. The glue gun according to claim 6 wherein the body comprises a passage for communicating the second section of the barrel with the combustion chamber.

9. The glue gun according to claim 6 wherein the heat sink is inserted in the second section of the barrel.

10. The glue gun according to claim 2 wherein the heat sink comprises:
a tube for receiving the glue stick; and
a plurality of fins formed on the external side of the tube in order to define a plurality of curved passages for heated air between the internal side of the barrel and the external side of the tube.

11. The glue gun according to claim 1 wherein the nozzle comprises a first end connected with heat sink and a tapered second end extending to the exterior.

12. The glue gun according to claim 11 comprising a protective collar for shielding the nozzle except for the second end.
